(19) United States
(12) Patent Application Publication
(10) Pub. No.: US 2003/0233427 A1
(43) Pub. Date: Dec. 18, 2003

(54) System and method for storage network management

(75) Inventor: Yuichi Taguchi, Sunnyvale, CA (US)

Correspondence Address: SQUIRE, SANDERS & DEMPSEY L.L.P, 600 HANSEN WAY, PALO ALTO, CA, 94304-1043, US

(73) Assignee: Hitachi, Ltd., Tokyo (JP)

(21) Appl. No.: 10/158,297

(22) Filed: May 29, 2002

(51) Int. Cl. G06F 15/173

(52) U.S. Cl. 709/220; 709/223; 709/236

(57) ABSTRACT

A system for storage network management comprises: a local SAN manager client capable to receive SAN topology data from a local SAN manager; an IP network manager client capable to receive IP network topology data from an IP network manager; a database capable to store unified data structures; and a database management engine, communicatively coupled to the local SAN manager client, IP network manager client, and database, capable to convert received SAN topology data and received IP network topology data into unified data structures, the database management engine further capable to store the unified data structures in the database.

### TECHNICAL FIELD

This invention relates generally to storage networks, and more particularly, but not exclusively, provides a system and method for storage network management.

### BACKGROUND

Conventional storage network management software enables an operator to visualize the topology of a single type of network. For example, storage area network (“SAN”) management software enables an operator to view the topology of a fibre channel (“FC”) SAN. Further, Internet Protocol (“IP”) management software enables an operator to view the topology of an IP-based network. However, there is no storage network management software that enables an operator to view the topology of networks using both FC and IP technology.

This problem makes it hard to manage end-to-end communications between clients and storage devices. For example, clients usually have a connection to a network via IP. The requests issued by clients are transported via the IP network to application servers. The application server then downloads data from a storage device via a fiber channel SAN. If clients fail to download requested data, the network operator has to check for faults both in IP network and FC network in order to detect a failure point so as to validate end-to-end communications.

In addition, conventional FC SAN management software, unlike conventional IP management software, cannot enable an operator to view hierarchical maps of a network because there is no network segment concept as in IP (zoning technology is only a method of make logical sub-networks in a fibre channel network). Accordingly, convention FC management software displays an entire network, even if there are hundreds of devices in it. This can make it hard for an operator to locate a target device since there may be hundreds of devices displayed on a single network map.

Accordingly, a new system and method is needed for managing networks.

### SUMMARY

The present invention provides a system for managing storage networks. The system comprises a global SAN manager; a local SAN manager; and an IP network manager. The global SAN manager is communicatively coupled to the local SAN manager and IP network manager. The local SAN manager retrieves topology data from a FC SAN and forwards the data to the global SAN manager. The IP network manager retrieves topology data from an IP network and forwards the data to the global SAN manager.

The global SAN manager comprises a GUI; Map Edit Program; Storage Network Map Database (“DB”); a Storage Network Map DB Management Engine; a local SAN manager client; and an IP network manager client. The SAN manager client and IP network manager client are programs that communicate with the local SAN manager and IP network manager respectively. The clients receive topology data and forward it to the DB management engine that converts received topology into a unified data structure for storage in the DB. The GUI displays maps of the combined FC/IP network using data stored in the DB. The Map Edit Program retrieves sub-maps based on data received from an operator via the GUI.

The present invention further provides a method for managing networks. The method comprises: initializing database communication configuration; getting FC SAN topology map data; getting IP network topology map data; converting the FC SAN and IP network topology data into unified data structures; and storing the data structures into the DB. In addition, the method may further comprise displaying a combined FC/IP map using unified data stored in the DB.

Accordingly, the system and method advantageously enables display of network topologies that use both IP and FC technology.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a diagram illustrating a hierarchical storage network mapping according to an embodiment of the invention;

FIG. 2 is a diagram illustrating a FC SAN topology sub-map;

FIG. 3 is a diagram illustrating a storage network management architecture according to an embodiment of the invention;

FIG. 4 is a diagram illustrating an example computer;

FIG. 5 is a diagram illustrating a software architecture of a global storage network manager according to an embodiment of the invention;

FIG. 6 is a diagram illustrating an example storage network map database data structure;

FIG. 7 is a flowchart illustrating a method for managing a global storage network;

FIG. 8 is a diagram illustrating an example of data received from a local SAN manager;

FIG. 9 is a diagram illustrating an example of data received from an IP network manager;

FIG. 10 is a flowchart illustrating a method for constructing a storage network sub-map;

FIG. 11 is a flowchart illustrating a method for displaying sub-maps; and

FIG. 12 is a flowchart illustrating a method for displaying zone objects or FC sub-maps upon discovery of an FC switch.

### DETAILED DESCRIPTION OF THE ILLUSTRATED EMBODIMENTS

The following description is provided to enable any person skilled in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

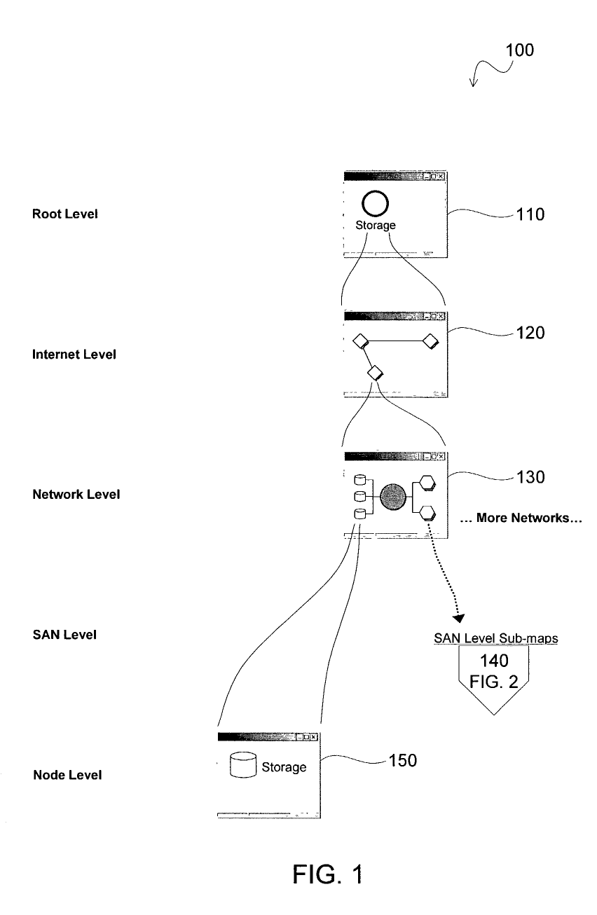

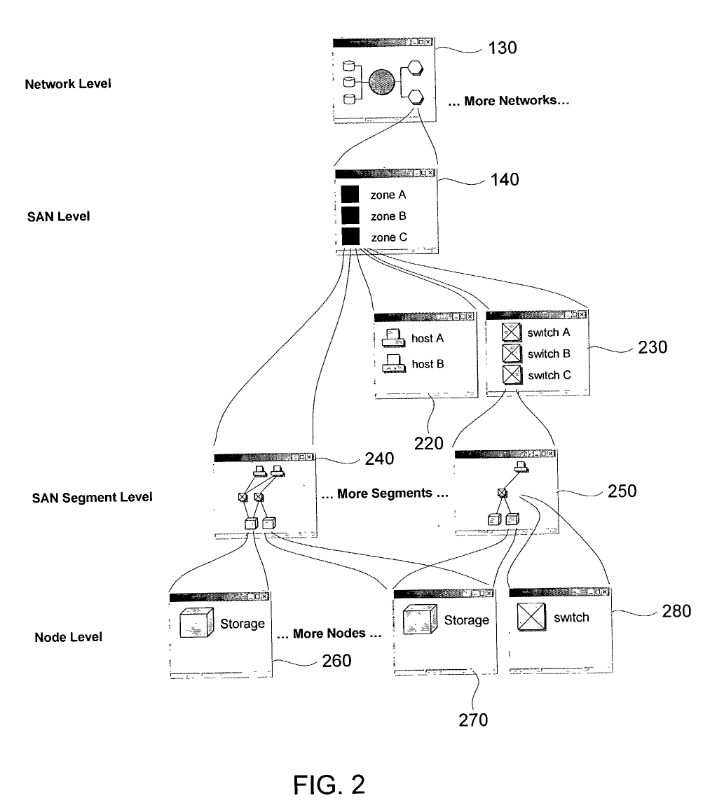

FIG. 1 is a diagram illustrating a hierarchical storage network mapping 100 according to an embodiment of the invention. The mapping 100 comprises five hierarchical levels including a root level 110; Internet level 120; network level 130; SAN level 140; and node level 150. The mapping 100 may include both IP network and FC technology-based devices. The root level 110 can represent the entire network or just classes of network devices, such as the part of a network having storage devices. The network level 130 displays storage devices of both IP network and FC-based technology. At the SAN level 140, SAN level sub-maps are available, as will be discussed in further detail in conjunction with FIG. 2.

FIG. 2 is a diagram illustrating a FC SAN topology sub-map 140. The sub-map comprises zone views and device views. The SAN level view 210 shows different zones in the SAN. Clicking on a zone, such as zone C, leads to both device views and zone views. Device views, such as host view 220 and switch view 230 show devices (both logical and physical) that are accessible from selected devices. For example, clicking on switch C in view 230 leads to segment view 250 showing a host and two storage devices accessible from switch C. In contrast, clicking on zone C also leads to SAN segment view 240 that shows all the devices in the zone and their topology.

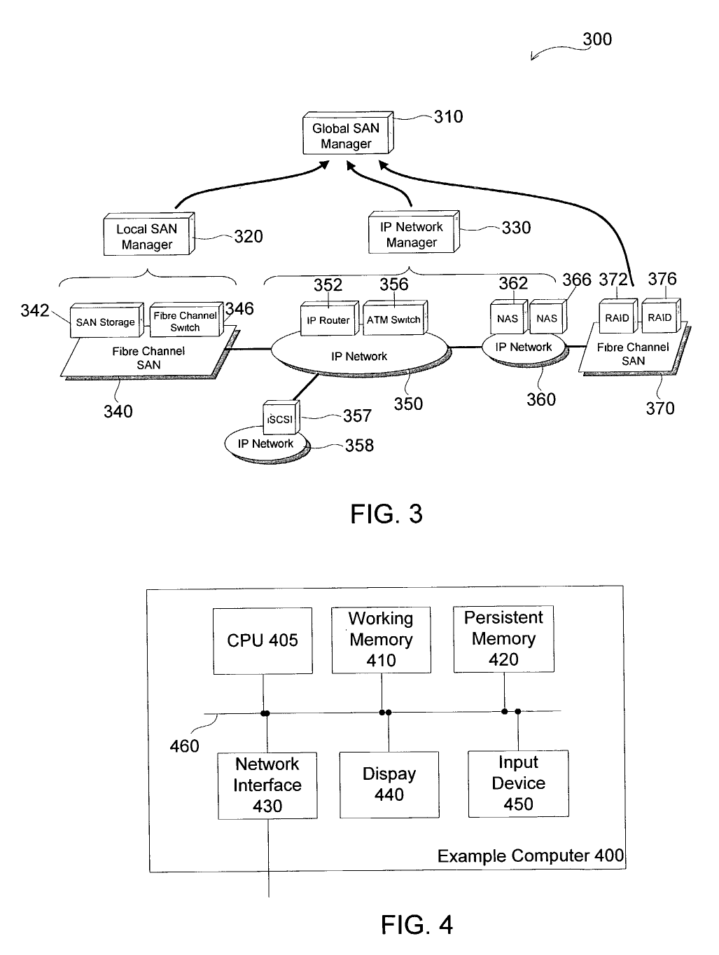

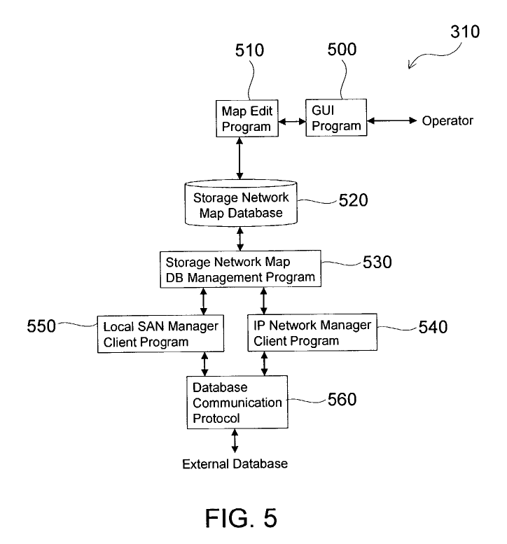

FIG. 3 is a diagram illustrating a storage network management architecture 300 according to an embodiment of the invention. The architecture 300 includes a global SAN manager 310; local SAN manager 320; and an IP network manager 330. The managers 310, 320 and 330 are communicatively coupled to various networks. For example, local SAN manager 320 is communicatively coupled to FC SAN 340, which comprises SAN storage 342 and FC switch 346. IP network manager 330 is communicatively coupled to IP network 350, which comprises IP router 352 and ATM switch 356; to IP network 358, which comprises iSCSI 357; and to IP network 360, which comprises NAS 362 and NAS 366. Global SAN manager 310 is communicatively coupled to FC SAN 370, which comprises RAIDs 372 and 376. The global SAN manager 310 is communicatively coupled to the local SAN manager 320 and IP network manager 330 and receives topology data from the local SAN manager 320 and IP network manager 330. In addition, the global SAN manager 310 can generate topology data directly from FC network devices, without the need for local SAN manager 320. Upon receiving the topology data, the global SAN manager 310 converts the received data into a unified data structure for storage in a database, as will be discussed in further detail in conjunction with FIG. 5. In addition, the global SAN manager can display a unified topology of both FC and IP network devices based on the unified data stored in the database.

FIG. 4 is a block diagram illustrating an example computer 400 in accordance with the present invention. In an embodiment of the invention, the global SAN manager 310 may include or be resident on a computer that is substantially similar to example computer 400. The example computer 400 includes a central processing unit (“CPU”) 405; working memory 410; persistent memory 420; network interface 430; display 440 and input device 450, all communicatively coupled to each other via system bus 460. CPU 405 a processor capable to execute software stored in persistent memory 420. Working memory 410 may include random access memory (“RAM”) or any other type of read/write memory devices or combination of memory devices. Persistent memory 420 may include a hard drive, read only memory (“ROM”) or any other type of memory device or combination of memory devices that can retain data after example computer 400 is shut off. Network interface 430 is communicatively coupled, via wired or wireless techniques, to local SAN manager 320, IP network manager 330 and/or networks, such as FC SAN 370. Display 440 includes a liquid crystal display (“LCD”) display, cathode ray tube display or other display device. Input device 450 includes a keyboard, mouse, or other device for inputting data, or a combination of devices for inputting data.

One skilled in the art will recognize that the example computer 400 may also include additional devices, such as network connections, additional memory, additional processors, LANs, input/output lines for transferring information across a hardware channel, the Internet or an intranet, etc. One skilled in the art will also recognize that the programs and data may be received by and stored in the system in alternative ways.

FIG. 5 is a diagram illustrating a software architecture of global storage network manager 310 according to an embodiment of the invention. Global storage network manager 310 comprises a GUI program (“GUI”) 500; map edit program 510; a storage network map database (“DB”) 520; a storage network map database management program (“DB management program”) 530; a local SAN manager client program 550; and an IP network manager client program 540.

GUI 500 displays sub-maps, such as those shown in FIG. 1 and FIG. 2, of a network having FC SAN and/or IP network technology. The map edit program 510 loads objects based on operator input received via GUI 500. Upon receiving a command from GUI 500, the map edit program 510 retrieves relevant data from DB 520 and forwards it to GUI 500 for display.

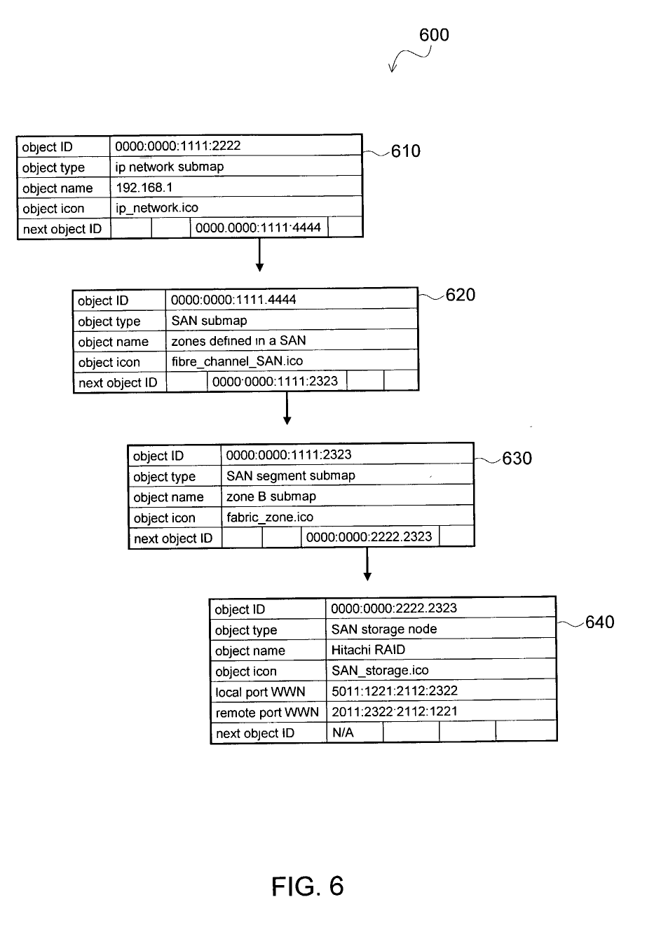

DB 520 stores topology data from both FC SAN networks and IP networks in unified data structures. DB management program 530 manages DB 520 by converting data received from local SAN manager client program 550 and IP network manager client program 540 into the unified data structure of DB 520. The unified data structure will be discussed in further detail in conjunction with FIG. 6. In addition, DB management program 530 can convert topology data received directly from a FC SAN network into unified data structures.

Local SAN manager client program 550 and IP network manager client program 540 use database communication protocol 560, such as net-8 protocol, to retrieve topology data from local SAN managers, such as local SAN manager 320, and IP network managers, such as IP network manager 330, respectively.

FIG. 6 is a diagram illustrating an example storage network map database data structures (“data structure”) 600. The data structures 600 contain both IP network sub-maps and SAN sub-maps. The data structures 600 comprise four tables 610, 620, 630 and 640. Each table, represents a sub-map object and has an object ID field; object type field; object name field; object icon field; and next object ID fields. In addition, tables for FC objects, such as table 640, include a local port WWN field and a remote port WWN field.

The object ID field holds an identification number of the object table. The object type field holds data representing the type of object. The object name field holds data representing the name of the object. In an embodiment of the invention, GUI 500 displays the data in the object name field. The data in the object name field may also be the IP subnet address. The object icon field holds an icon file name corresponding to the object. For example, in table 630, GUI 500 displays the object corresponding to table 630 as an icon from a file called “fabric_zone.ico.” The next object ID fields include a list of object table IDs that are mapped on the sub-map. The local port WWN and remote port WWN fields hold FC port identification data. The remote port WWN identifies a port of a remote device coupled to the local device.

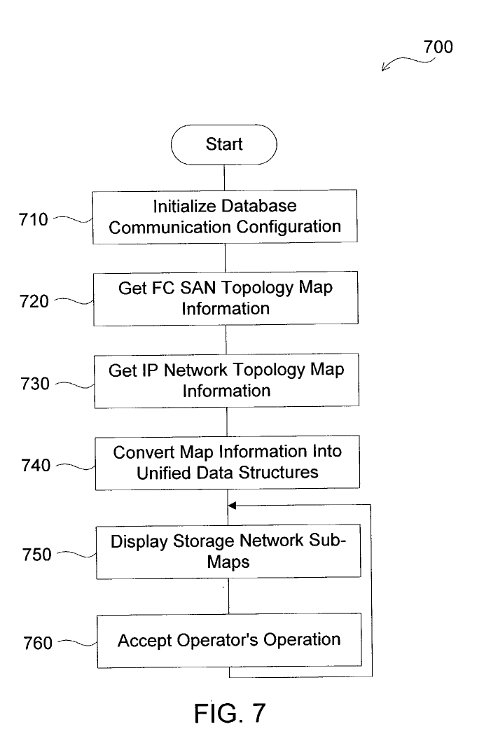

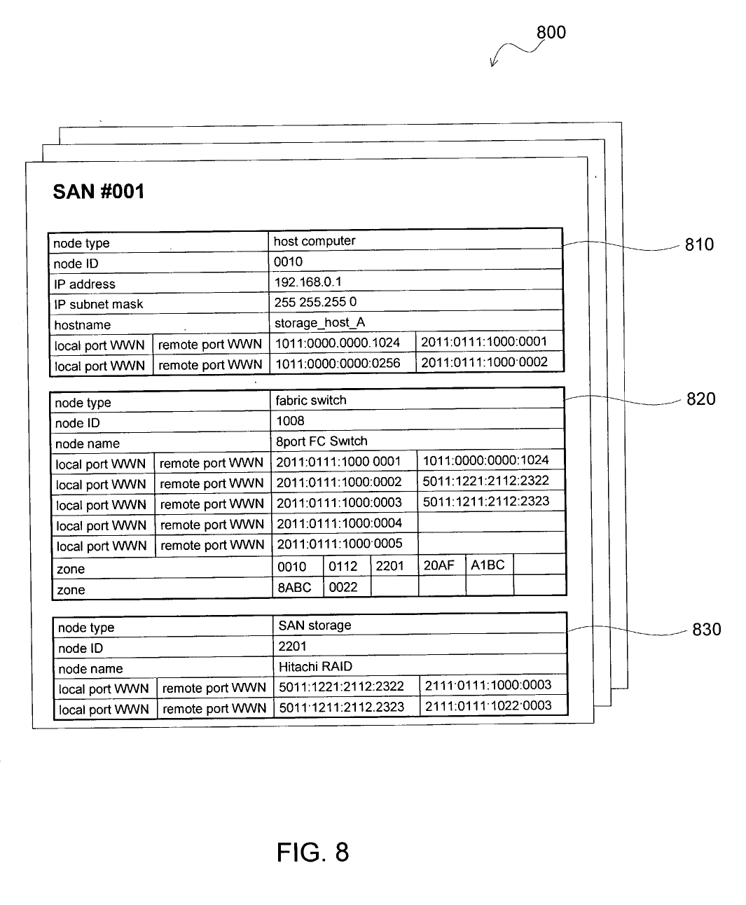

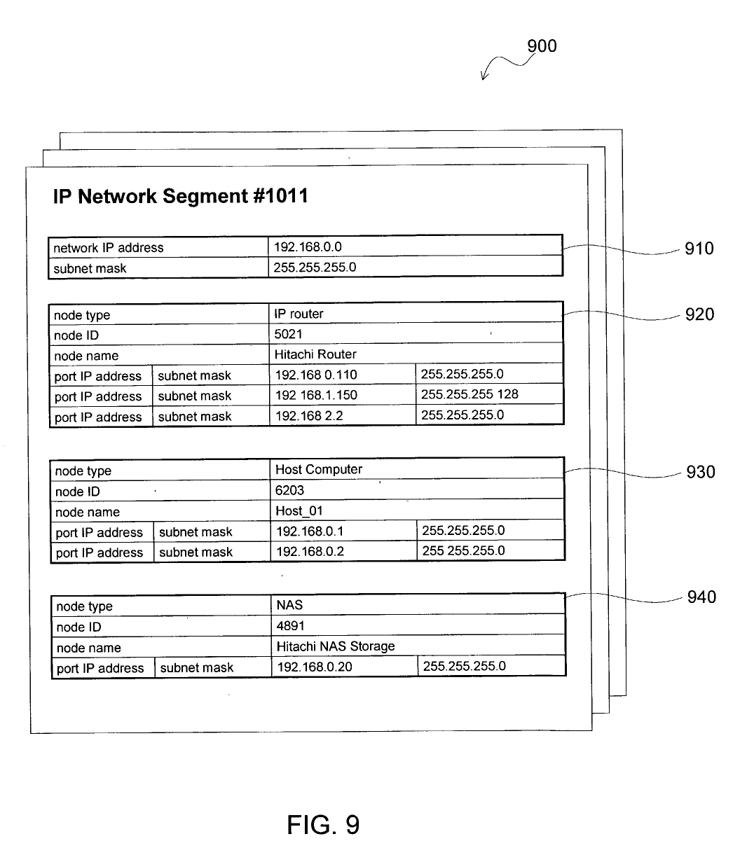

FIG. 7 is a flowchart illustrating a method 700 for managing a global storage network. The method 700 comprises first initializing (710) the DB 520 communication configuration. Next, the global SAN manager 310 gets (720) FC SAN topology map information, such as data 800 (FIG. 8) from local SAN manager 320 via local SAN manager client program 550 using database communication protocol 560. Global SAN manager 310 then gets (730) IP network topology map information, such as data 900 (FIG. 9), from IP network manager 330 via IP network manager client program 540 using database communication protocol 560.

After the global SAN manager 310 gets (720, 730) all topology mapping data, the global SAN manager 310, using the DB management program 530, converts (740) the data into unified data structures and stores the data structures in DB 520. Global SAN manager 310, using GUI 500, then displays (750) a root map based on data structures in DB 520. Afterwards, GUI 500 accepts (760) operator input to modify maps and/or to display sub-maps. The method 700 then returns to displaying (750) to display sub-maps according to the operator's input.

FIG. 8 is a diagram illustrating an example of data 800 received from a local SAN manager. Each table in data 800 includes a node type field; node ID field; IP address field; IP subnet mask field; hostname field; local and remote WWN fields; and zone field.

The node type field represents a parameter of device type. The node ID field represents a unique identification number of the node. The IP address and IP subnet mask fields represents the IP address parameter assigned to a device port. Typical FC devices, such as host computers, switches and storage each have an IP network port as well as an FC port, which is used for data I/O and for SNMP communication. The hostname field represents the hostname that is assigned to the host computer. The local and remote WWN field represents the FC WWN assigned to the local and remote port. A pair of the local and remote WWN means a connection between local and remote devices. In this example, a port “1011:0000:0000:1024” of the host computer and a port “2011:011:1000:0001” of fabric switch is connected to the device. The zone field represents a list of node IDs that belong to a single fabric zone group. In this example, a host computer of node ID “0010” and a SAN storage of node ID “2201” are defined in a single fabric zone group.

FIG. 9 is a diagram illustrating an example of data 900 received from an IP network manager. Each object represented by a table in data 900 includes a node type field; a node ID field; a node name field; a port IP address field and a subnet mask field. The network IP address and subnet mask represents a network part of IP address. This is not an IP address assigned to a specific network port, but specifies the network segment itself. The node type, node ID, and node name field are substantially similar to fields described in conjunction with FIG. 8. The combination of port IP address and subnet mask field represents the IP address assigned to a specific IP network port.

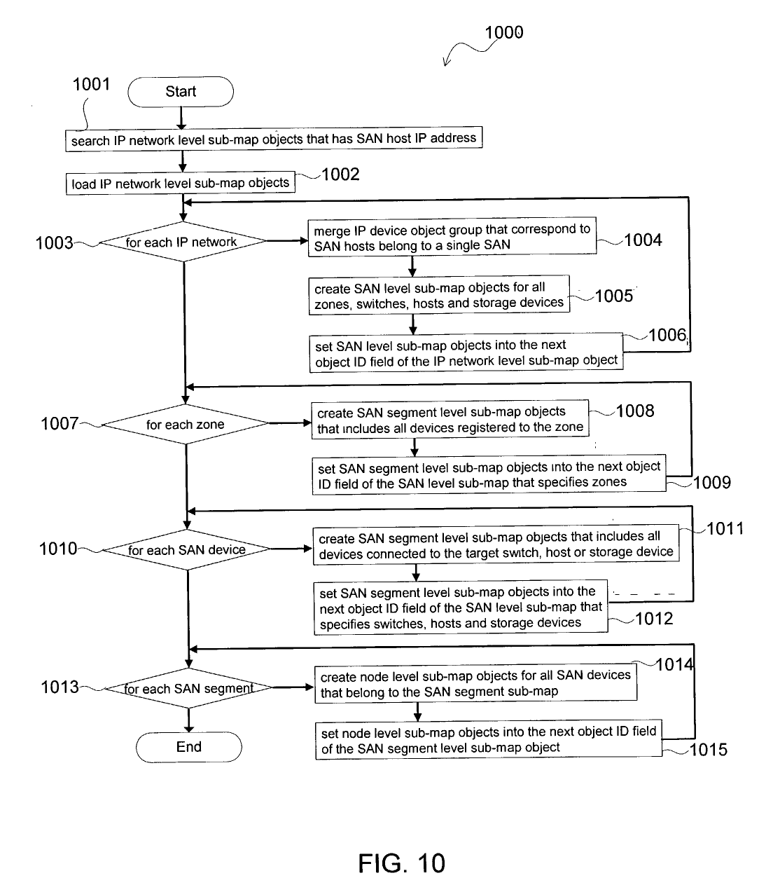

FIG. 10 is a flowchart illustrating a method 1000 for constructing a storage network sub-map. Method 1000 comprises DB management program 530 searches (1001) for IP network level sub-map objects that include FC SAN devices yielding IP network level sub-map objects that have IP addresses corresponding to IP addresses specified in SAN topology map information. The DB management program 530 then loads (1002) IP network level of sub-map objects.

For each IP network: the DB management program 530 finds devices that corresponds to SAN devices in the IP network level sub-map object. Then the SAN devices on the IP network sub-map are merged (1004) into a single SAN group. The next object ID field values that represent SAN device are cleared. The DB management program 530 then creates (1005) SAN level sub-map objects for all zones and devices that are SAN objects. Object ID, object type, object name, object icon fields are also filled. Finally, the DB management program 530 sets (1006) one of the SAN level sub-map objects created (1005) into the next object ID of the IP network level of sub-map. As a result of merging (1004), creating (1005), and setting (1006), the SAN devices on the IP network sub-map are merged and switched into a SAN level sub-map object.

For each zone: The DB management program 530 creates (1008) “zone views” of SAN segment level sub-map objects. Object ID, object name, object type and object icon fields are filled with appropriate values for each zone. Next object ID fields are filled with node ID values of devices that belong to the zone. The DB management program 530 sets (1009) the object ID value of SAN segment level sub-map objects created (at 1008) into the next object ID field of the SAN level sub-map object created (at 1005).

For each SAN device: the DB management program 530 creates (1011) “device views” of SAN segment level sub-map objects. Object ID, object name, object type and object icon fields are filled with appropriate values for each device. Next object ID fields are filled with node ID values of devices that are accessible from the target device. The database management program 530 then sets (1012) the object ID value of SAN segment level sub-map objects created (at 1011) into next object ID field of the SAN level sub-map object created (at 1005).

For each SAN segment: the DB management program 530 creates (1014) node level sub-map objects. Object ID, object type, object name and object icon fields are filled with appropriate values. The DB management program 530 sets (1015) the object ID value of node level sub-map objects created (at 1014) into the next object ID field of the SAN segment level sub-map object created (at 1008 and 1011). The method 1000 then ends.

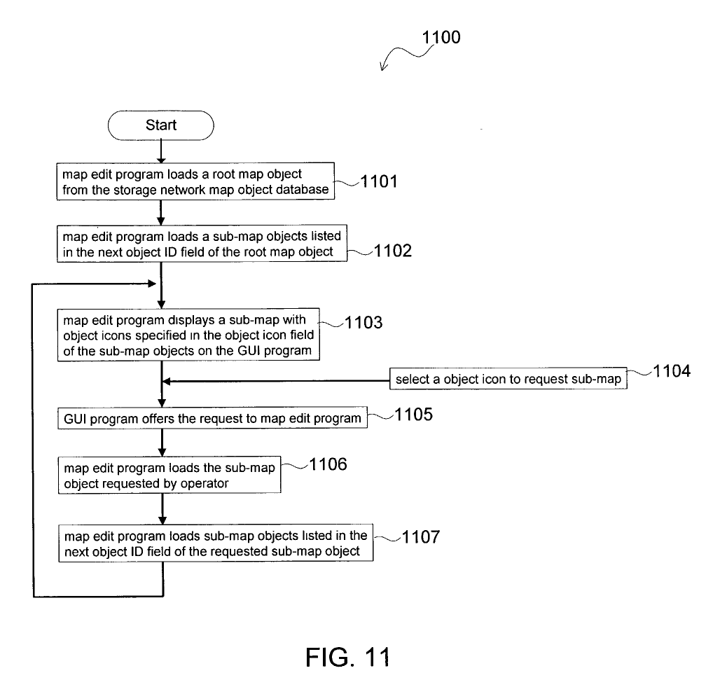

FIG. 11 is a flowchart illustrating a method 1100 for displaying sub-maps. The method 1100 comprises loading (1101), by the map edit program 510, a root map object from DB 520. The map edit program 510 further loads (1102) sub-map objects that are specified in next object ID fields of root map object. After loading (1102), the map edit program 510 displays (1103) a sub-map window that has object icons that were loaded (1102). Next, an operator selects (1104), via GUI 500, an object icon in order to request a sub-map display. The GUI 500 then issues (1105) a request to display sub-map. The map edit program 510 then loads (1106) the sub-map object that is requested by the operator. The map edit program 510 loads (1107) the sub-map objects that are listed in the next object ID field of the requested sub-map object. The method 1100 then returns to displaying (1103) and repeats until terminated by the operator.

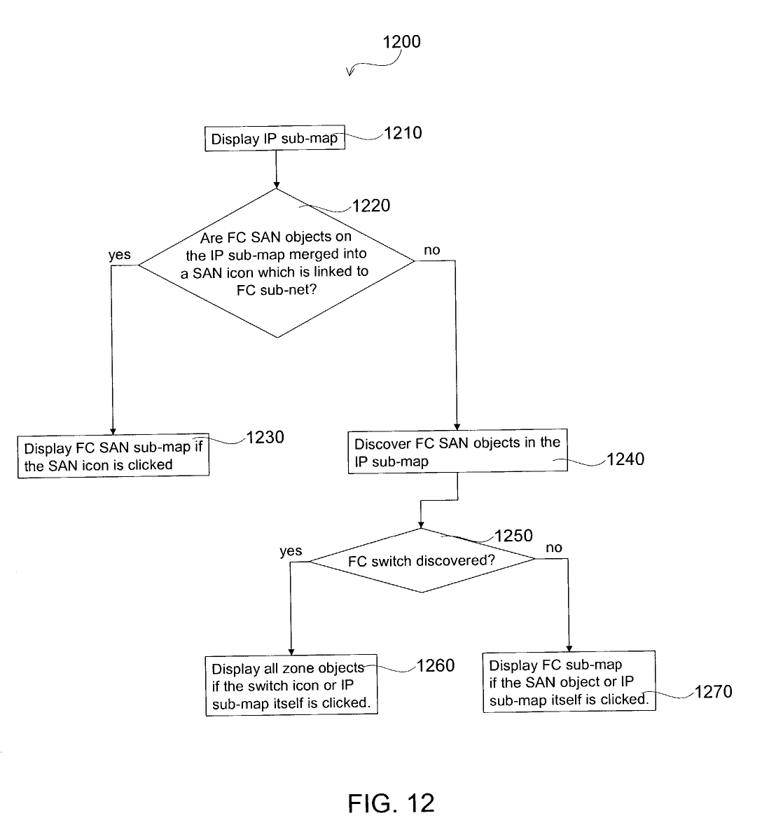

FIG. 12 is a flowchart illustrating a method 1200 for displaying zone objects or FC sub-maps upon discovery of an FC switch. The method 1200 comprises displaying (1210) an IP sub-map. There might be some objects on the sub-map that are also FC SAN objects, such as an FC switch, application server host and SAN gateway. These objects must have both at least one IP connection and an FC connection. These objects on the IP sub-map can be merged into a single “SAN” object icon.

Next, it is determined (1220) if the FC SAN objects on the IP sub-map are merged into a SAN icon, which is linked to an FC sub-net. If the FC SAN objects on the IP sub-map are merged into the SAN icon, then the FC SAN sub-map is displayed (1230). If the FC SAN objects on the IP sub-map are not merged into a SAN object, then:

The global SAN manager 310 discovers (1240) SAN objects within the IP sub-map, such as FC switches, SAN hosts, and storage devices. Originally, the network management software can check device type by referring to SNMP messages. It can also be available to see if the objects have multiple network ports and if both IP and FC ports are in it. Furthermore, “HBA API” is an ordinal method to manage FC ports on SAN host objects.

After the discovery (1240) process, the global SAN manager 310 checks (1250) for the existence of FC SAN switch within the discovered objects.

If an FC switch is discovered, the global SAN manager 310 loads and displays (1260) the zone information from the FC switch, and then displays all zone objects or zone sub-maps on the screen when the switch object is clicked. Alternatively, all the zone objects can be displayed by a user clicking the entire IP sub-map.

If an FC SAN switch is not discovered, the global SAN manager 310 displays (1270) a FC SAN sub-map that includes the FC SAN objects such as the SAN host or the storage. Alternatively, the FC SAN objects can be displayed upon a user clicking the entire IP sub-map. The method 1200 then ends.

Accordingly, the system and methods described above enable management of an entire FC storage network regardless of the number of devices; enable management of IP and FC network seamlessly from a integrated GUI interface; enables management of IP storage device with FC storage; enables finding easily a target object following a drill-down operation; enables the making of logical device groups in FC SANs using device view; and enables management of multiple “SAN islands” distributed on the network.

The foregoing description of the illustrated embodiments of the present invention is by way of example only, and other variations and modifications of the above-described embodiments and methods are possible in light of the foregoing teaching. Components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A method, comprising:
receiving SAN topology data;
receiving IP network topology data;
converting the SAN topology data and IP network topology into unified data structures; and
storing the unified data structures in a database.

2. The method of claim 1, wherein the unified data structures include hierarchical data.

3. The method of claim 2, further comprising displaying at least one of the unified data structures from a hierarchical level in a graphical format.

4. The method of claim 1, wherein the SAN topology data is received from a local SAN manager.

5. The method of claim 1, wherein the IP network topology is received from an IP network manager.

6. The method of claim 1, wherein the unified data structures include zoning information.

7. The method of claim 5, further comprising displaying the unified data structures by zone in a graphical format.

8. The method of claim 1, further comprising displaying at least one unified data structure corresponding to at least one device that is accessible both physically and logically from a target device.

9. A computer-readable medium storing instructions to cause a computer to perform a method, the method comprising:
receiving SAN topology data;
receiving IP network topology data;
converting the SAN topology data and IP network topology into unified data structures; and
storing the unified data structures in a database.

10. The computer-readable medium of claim 9, wherein the unified data structures include hierarchical data.

11. The computer-readable medium of claim 9, wherein the method further comprises displaying at least one of the unified data structures from a hierarchical level in a graphical format.

12. The computer-readable medium of claim 9, wherein the SAN topology data is received from a local SAN manager.

13. The computer-readable medium of claim 9, wherein the IP network topology is received from an IP network manager.

14. The computer-readable medium of claim 9, wherein the unified data structures include zoning information.

15. The computer-readable medium of claim 14, wherein the method further comprises displaying the unified data structures by zone in a graphical format.

16. The computer-readable medium of claim 9, wherein the method further comprises displaying at least one unified data structure corresponding to at least one device that is accessible both physically and logically from a target device.

17. A system, comprising:
means for receiving SAN topology data;
means for receiving IP network topology data;
means for converting the SAN topology data and IP network topology into unified data structures;
means for storing the unified data structures in a database; and
means for displaying the unified data structures in a graphical format.

18. A system, comprising:
a local SAN manager client capable to receive SAN topology data from a local SAN manager;
an IP network manager client capable to receive IP network topology data from an IP network manager;
a database capable to store unified data structures; and
a database management engine, communicatively coupled to the local SAN manager client, IP network manager client, and database, capable to convert received SAN topology data and received IP network topology data into unified data structures, the database management engine further capable to store the unified data structures in the database.

19. The system of claim 18, wherein the unified data structures include hierarchical data.

20. The system of claim 20, further comprising a GUI capable to display at least one unified data structure from a hierarchical level in a graphical format.

21. The system of claim 18, wherein the unified data structures include zoning data.

22. The system of claim 21, further comprising a GUI capable to display at least one unified data structure from a zone in a graphical format.

23. The system of claim 18, further comprising a GUI capable to display at least one unified data structure corresponding to at least one device that is accessible both physically and logically from a target device.

24. A method of viewing topology of both of a Storage Area Network (SAN) and an Internet Protocol (IP) network, the method comprising the steps of:
viewing Internet Protocol (IP) subnet segments on a screen; and
when a subnet on the screen is selected, viewing zones provided by a switch which is in the SAN and in the selected IP subnet segment.

25. A topology viewer for both of a Storage Area Network (SAN) and Internet Protocol (IP) network, comprising:
means for viewing Internet Protocol (IP) subnet segments on a screen; and
when a subnet on the screen is selected, means for viewing zones provided by a switch which is in the SAN and in the selected IP subnet segment.
